(19) United States
(12) Patent Application Publication
(10) Pub. No.: US 2004/0107139 A1
(43) Pub. Date: Jun. 3, 2004

(54) Service providing method, server device, medium and program

(75) Inventor: Toshiro Shibanuma, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/703,484

(22) Filed: Nov. 10, 2003

Related U.S. Application Data
(63) Continuation of application No. PCT/JP01/03900, filed on May 10, 2001.

(51) Int. Cl. G06F 17/60

(52) U.S. Cl. 705/14

(57) ABSTRACT

A service method for providing a service together with advertising information by utilizing bidirectional communications. The servicing method comprises steps of: providing (S2) the advertisement information; prompting (S3) the input of discriminating information on the advertisement information; and providing (S7) the service after the inputting of the discriminating information.

This is a continuation of Application PCT/JP01/03900, filed on May 10, 2001, now abandoned.

### BACKGROUND OF THE INVENTION

1. Technical Field

The present invention relates to a technology for providing an advertisement.

2. Background Arts

It has hitherto been conducted on the Internet that a service provider provides a service user with a service and collects a value equivalent thereto. This type of service can be exemplified such as providing a variety of information on the Internet, providing various categories of contents such as programs, games, images and so on. The service provider collected a fee as a value equivalent to the service from the service user.

Further, the service provider, instead of collecting the fee from the service user, also distributed an advertisement accompanied by providing the service. Then, there was a case where the service provider acquires the value equivalent to the service by collecting an advertisement cost from the requester of the advertisement described above.

Such a service for acquiring the value equivalent thereto is not limited to what is on the Internet. For example, in the dial Q² (Trade mark) service provided by East Japan Telegraph & Telephone Co., Ltd. or Western Japan Telegraph & Telephone Co., Ltd., there is a case in which the content provider might provide a voice content. There is also a case where the service provider might collect a fee for utilizing this voice content from the audience.

Moreover, the content provider outputs a voice advertisement together with the voice content as the case may be. In this case, the content provider, instead of collecting the fee from the audience, collects an advertisement cost from an advertisement requester.

Further, in the telephone connection services, there was a telephone service for making the user listen to the voice advertisement for a predetermined period of time. In this telephone service, the advertiser pays an advertising cost to a telephone company, and the user can utilize the telephone line with no charge as a reward for listening to the voice advertisement.

According to the system for collecting the fee from the user, however, there arose such a problem that the user does not pay the fee unless the service has an extremely high quality. Another problem was that there is not yet settled an environment in which the user pays the fee in a carefree way on the Internet.

On the other hand, the system for collecting the cost for running the advertisement from the advertiser thereof has no assurance that the user is to see or hear the advertisement, and the advertiser has such an anxiety that a sufficient effect of the advertisement might not be obtained.

### SUMMARY OF THE INVENTION

The present invention was devised in view of such problems inherent in the prior arts. It is an object of the present invention to provide a service providing technology enabling a user to receive a service without paying a charge, enabling a service provider to receive a value equivalent thereto from an advertise, and further enabling the advertiser to obtain an assurance that the user is to see or hear the advertisement.

For solving the above problems, the present invention adopts the following means. Namely, the present invention is a service providing method of providing a service together with advertisement information by utilizing bidirectional communications, this method comprising steps of providing (S2) the advertisement information, prompting (S3) an input of identifying information related to the advertisement information, and providing (S7) the service after the identifying information has been inputted.

Further, the present invention is a server device (1), connected to a terminal device (2) through bidirectional communications, providing a service together with advertisement information to the terminal device (2), this server device comprising a providing module (3) providing the advertisement information to the terminal device (2), a prompting module (3) prompting an input of identifying information related to the advertisement information via the terminal device (2), and reading the identifying information, and a service module (3) providing the service after the identifying information has been inputted.

Preferably, the identifying information may be information on a name of an enterprise, a name of a commercial article, a brand and a trademark as an advertising target based on the advertisement information, information describing the enterprise, information describing the commercial article, information exhibiting an advertising effect with respect to the enterprise, information exhibiting an advertising effect with respect to the commercial article, or a name of an organization.

Preferably, the above server device may further comprise an accounting module charging an enterprise as an advertising target based on the advertisement information or an enterprise related to a commercial article as the advertising target based on the advertisement information, a fee for providing the advertisement information.

Preferably, the above service may be a service of distributing a digital content. Herein, the digital content connotes a document, an image, a moving image, a voice, a game or digital data describing a computer program, and so forth.

Preferably, the above accounting module may determine the fee on the basis of an input count of the identifying information.

Moreover, the present invention may also be a program for making a computer actualize any one of the functions given above. Still further, the present invention may be what such a program is recorded on a readable-by-computer recording medium.

### BRIEF DESCRIPTION OF THE DRAWINGS

FIG. 1 is a view of a system architecture of an information processing system in an embodiment of the present invention;

FIG. 2 shows a layout of a screen displayed on a terminal 2;

FIG. 3 is an explanatory view of a system operation of the information processing system;

FIG. 4 is a flowchart showing a processing procedure of the information processing system;

FIG. 5 is a flowchart showing a process of the information processing system that charges an advertisement fee corresponding to an input count of a name of an enterprise; and

FIG. 6 is a flowchart showing a line connection process of a telephone switching system.

### DETAILED DESCRIPTION OF THE PREFERRED EMBODIMENTS

A preferred embodiment of the present invention will hereinafter be described with reference to the drawings.

<System Architecture>

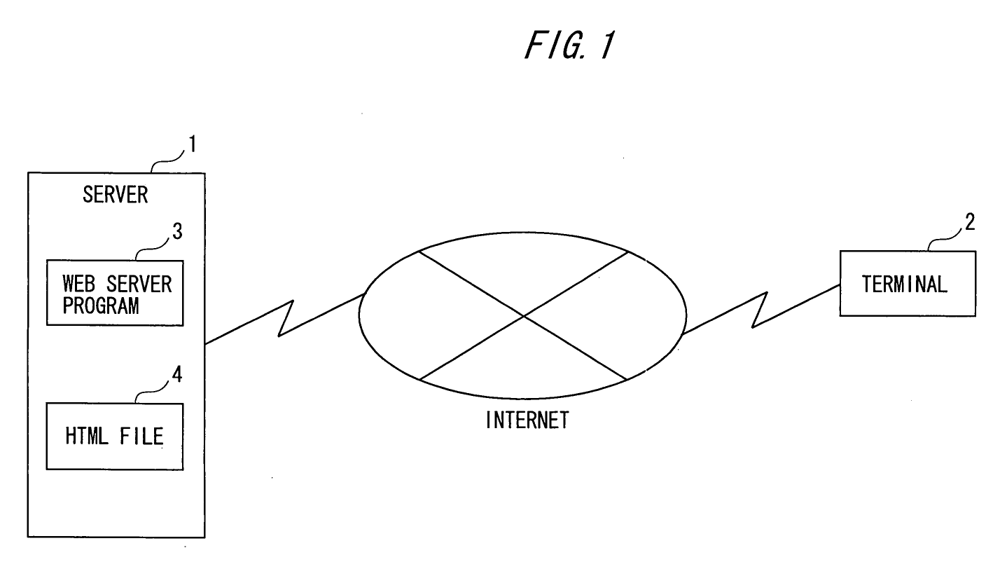

FIG. 1 is a view of a system architecture of an information processing system in the embodiment of the present invention.

As shown in FIG. 1, this information system is configured by connecting a server 1 and a terminal to each other via the Internet.

The server 1 is constructed of a CPU, a memory, a hard disk, a communication interface, etc., which are herein unillustrated. The server 1 develops a Web server program 3 on the memory and executes this program 3 in the CPU. Through this operation, the server 1 functions as a Web site.

Further, the server 1 has an HTML (HyperText Markup Language) file 4 on the hard disk. The HTML file 4 is recorded with contents and advertisements that are provided on the Web site. Moreover, the HTML file 4 contains pieces of link information for linking to HTML files and programs held by other servers 1.

The server 1 provides a user with a variety of contents and advertisements through its own HTML file 4 and through the HTML files and the programs on other servers 1 that are linked from the HTML file 4. The function as the Web site, the architecture or the operation of the server 1 described above are broadly known.

The terminal 2 is installed on a user site, receives a variety of services provided from the server 1 on the basis of HTTP (HyperText Transfer Protocol), and transfers these services to the user. The “services” from the server 1 herein connote such as displaying the contents, displaying the advertisements, etc., or downloading the programs, and so forth.

The terminal having such a function is, for instance, a personal computer, a cellular phone, a PDA (Personal Digital Assistant), a set-top box for a cable television and for satellite broadcasting, a digital television, a car-installed terminal, etc.

This type of terminal 2 includes a CPU, a memory, a communication interface, a display unit, an input unit, etc. A MODEM for accessing a telephone line, a dialup router, an ADSL (Asymmetric Digital Subscriber Line) interface utilizing the telephone line, etc. are each known as the communication interface.

Further, the display unit involves the use of a CRT (Cathode Ray Tube), a liquid crystal display, etc.

Moreover, the input unit involves the use of a keyboard, a pointing device and so on. The pointing device is one of, for example, a mouse, a trackball, a stick type or laser system pointing device, an electrostatic touch pad, a touch panel, etc.

The CPU in the terminal 2 executes a Browser program developed on the memory and receives the service provided from the server 1 on the basis of the HTTP (HyperText Transfer Protocol). A general architecture and operation of the terminal 2 described above are broadly known.

<Screen Layout>

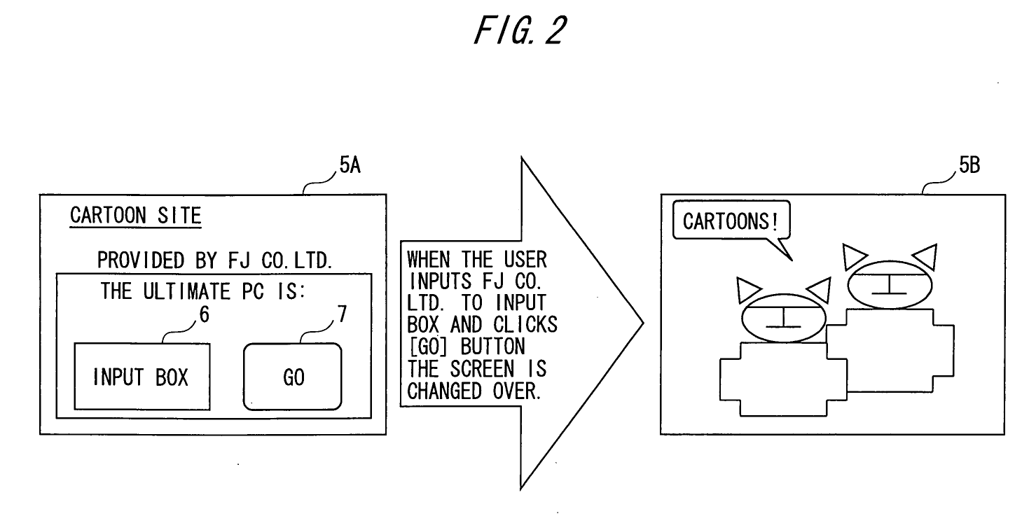

FIG. 2 shows a layout of a screen displayed on the terminal 2. The Browser program executed on the terminal 2 requests the server 1 to provide pieces of data that structure the screen.

The server 1 transmits, based on the HTML file 4, etc., the data structuring the screen shown in FIG. 2. The Browser program on the terminal 2 displays, based on the data transmitted from the server 1, the screen illustrated in FIG. 2 on the display unit.

Referring to FIG. 2, there is displayed a first Web page (which will hereinafter be called a top page 5A) of a cartoon site as one category of the Web sites. In this top page 5A, there are displayed a title name of the site named “Cartoon site”, “sponsored by FJ Co., Ltd.” as a name of advertiser, “the ultimate PC is:” as advertising characters, an “input box 6” for inputting a character string, and a “go” button 7.

In response to this top page 5A, the user inputs the name of the advertiser such as FJ Co., Ltd.” to the input box 6 and clicks the “go” button 7 by use of the pointing device, e.g., the mouse, thereby changing the screen over to a next screen (which will hereinafter be referred to as a content providing screen 5B).

A content of the cartoon provided by the cartoon site is displayed on the content providing screen 5B. Thus, a feature of this cartoon site lies in such a point that the content is provided to only the user who inputted the name of (FJ Co., Ltd. in FIG. 2) of the advertiser for the cartoon site to the input box 6 of the top page 5A. While on the other hand, even when a user who did not input the name of the advertiser clicks the “go” button 7, the content providing screen 5B is not displayed.

<System Operation>

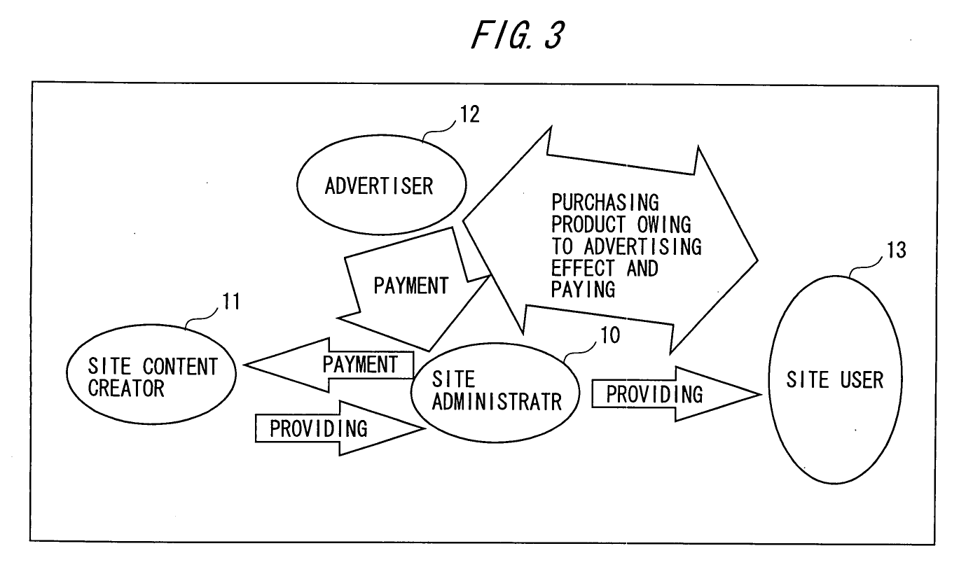

FIG. 3 shows an explanatory view of a system operation of the present information processing system. As shown in FIG. 3, this system is operated by a site administrator 10, a site content creator 11, an advertiser 12 and a site user 13 (user).

In response to a request from the site administrator 10, the site content creator 11 creates a content, e.g., a cartoon, etc. on the content providing screen 5B in FIG. 2, which is provided to the site user 13 from the Web site. The site content creator 11 provides the site administrator 10 with the created content. Provided with this content, the site administrator 10 pays the site content creator 11 a value equivalent to the content.

The advertiser 10 pays an advertising fee and makes a request for placing an advertisement on the Web page of the site. The site administrator 10 displays the advertisement requested by the advertiser 12 and the content on the Web page of the self-site.

As explained in FIG. 2, however, the Web page is hierarchically structured. Namely, the Web page of the site administrator 10 contains a first page and a second page. Then, upon an input of the name of the advertiser 12 is inputted with respect to the advertisement displayed on the first page, the content is displayed on the second page. The thus structured Web page is provided to the site user 13 from the site administrator 10.

The site user 13 at first inputs the name of the advertiser 12 with respect to the advertisement on the first page (e.g., the same screen as the top page 5A in FIG. 2). Then, the content is provided as on the content providing screen 5B shown in FIG. 2.

The site user 13 utilizes the content free of charge. Further, if a content of the advertisement stimulates a purchasing desire of the site user 13, the site user 13 is to purchase a commercial article as an advertising target. This being purchased, a value equivalent to the commercial article is paid to the advertiser 12.

<Operation and Effect>

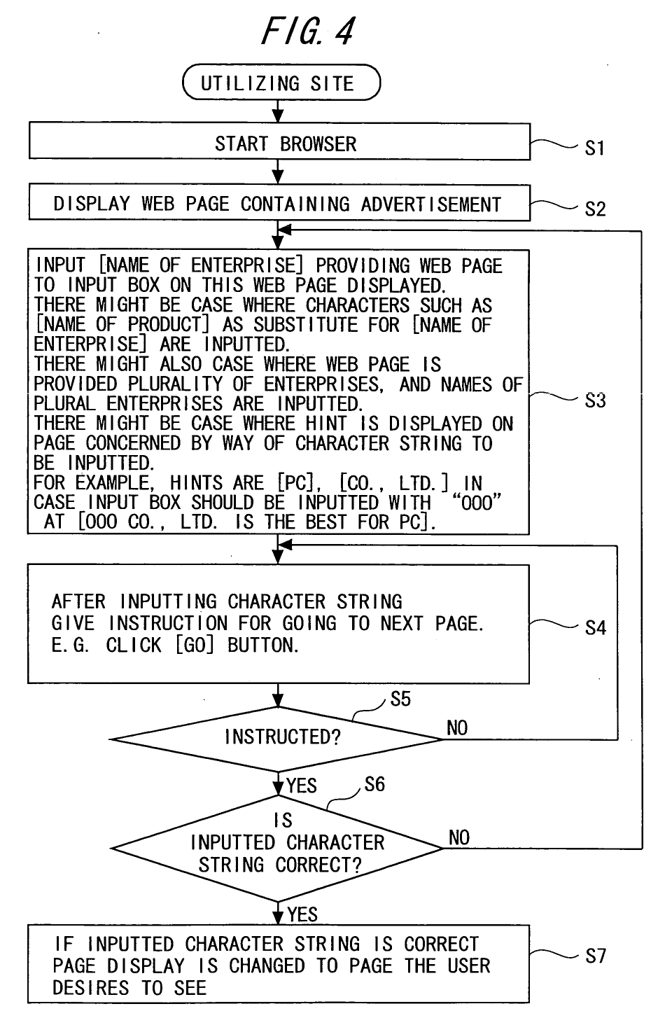

FIG. 4 shows a processing procedure of the present information processing system. The server 1 executes a process shown in FIG. 4 in accordance with the data transmitted from the terminal 2, thereby providing a service to the site user 13 via the terminal 2.

To begin with, the terminal 2 starts Browser as the user operates (S1). Next, the site user 13 requests the terminal 2 to display a desired Web page. The terminal 2 transmits this request to the server 1. The server 1, in response to this request, displays that Web page, e.g., the top page 5A, etc. in FIG. 2 on the terminal 2 (S2).

The site user 13 inputs a name of the enterprise, e.g., “FJ Co., Ltd.” shown in FIG. 2 that provides this page to the input box of the Web page displayed (S3).

Upon the input of the name of the enterprise that provides the page, the site user 13 gives an instruction for going to a next page. For instance as shown in FIG. 2, the “go” button 7 is clicked (S4). With this click, the terminal 2 notifies the server 1 that the name of the enterprise has been inputted and that the “go” button 7 has been clicked.

The server 1 judges whether the aforementioned name of the enterprise has been inputted or not and also whether the instruction for going to the next page has been given or not (S5).

The server 1, if unable to detect the above instruction, returns the control to S4 and waits for an instruction. While on the other hand, the server 1, when detecting the instruction for going to the next page, further judges in S3 whether the character string inputted is correct or not (S6).

If the character string inputted is incorrect, the server 1 returns the control to S3. Whereas if the character string inputted is correct, the server 1 makes the terminal 2 display a page (for example, the content providing page 5B in FIG. 2) for providing the content (S7).

As explained above, according to the information processing system in this embodiment, in case the site user displays the Web page of the site for providing the specified service, the site user is made to input the character string that intends the advertisement concerned such as the [enterprise name] of the enterprise having made the request for the advertisement on that Web page.

The site user inputs the character string, thereby obtaining an effect of being necessarily aware of the character string that intends the advertisement. With this effect, the advertiser can surely make the site user be conscious of the advertisement.

On the other hand, the site user needs a labor for inputting the character string of the advertisement. Owing to this labor, however, the site user can see a high-quality content created by expending finances.

<Modified Example>

The embodiment discussed above involves using the name of the enterprise as the character string that intends advertising and is used for making the site user be conscious of it. The embodiment of the present invention is not, however, limited to the scheme and the procedure described above. As a substitute for the name of the enterprise, the site user may be made to input, for example, a character string showing a name of a product, a name of a commercial article that are provided by this enterprise.

Further, if a plurality of enterprises provide one web page and one content, names of the plurality of enterprises may be inputted. As for a character string, a hint may be displayed on the page concerned. For example, in the case of having OOO inputted to the input box in connection with a banner advertisement such as “OOO Co., Ltd. is the best for personal computers”, [personal computers] and [Co., Ltd.]may be displayed as hints on the Web page.

The site administrator 10 collects a fixed amount of fee from the advertiser as a cost for running the advertisement. On this occasion, the site user inputs the name of the enterprise with the result that the high advertisement effect is to be obtained, and hence a higher fee than a normal advertisement may be set. Further, a fee collection method may be such that a fee corresponding to an input count of the site user's inputting the enterprise name may be set.

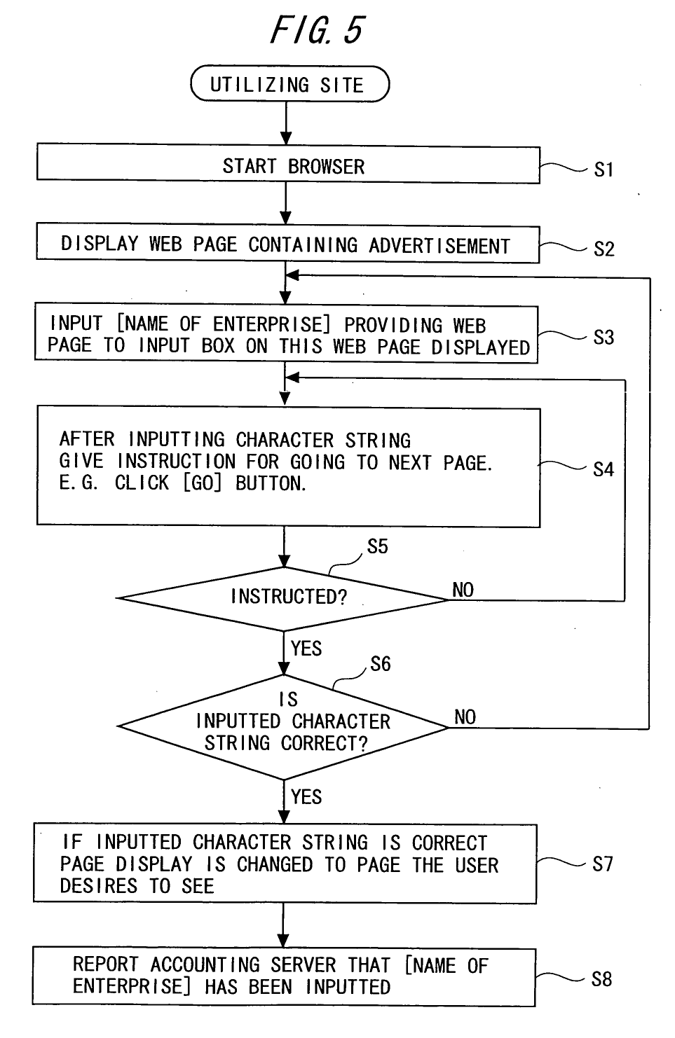

FIG. 5 shows a process of the information processing system that charges an advertisement fee corresponding to the input count of the name of the enterprise. In this process, a process in S1 through S7 is the same as FIG. 4 shows in the embodiment discussed above.

The server 1, after changing the page to be displayed on the terminal 2 over to the content providing page (e.g., the content providing screen 5B shown in FIG. 2), reports an unillustrated accounting server 1 that the enterprise name has been inputted (S8). The server 1 may, however, serve as the accounting server.

The accounting server counts and records the input count of the enterprise name reported. Then, the accounting server may claim the advertiser for an advertisement fee corresponding to this input count.

The site administrator 10 pays a part of the collected advertisement fees to the content creator (the creator of the cartoon in the example shown in FIG. 2). Moreover, another part of the collected advertisement fees turn out to be expenditures and a profit of the site administrator 10 himself or herself.

The advertiser places a highly effective advertisement and can expect sales of a larger number of products and services. Therefore, even if the advertisement expenditures are set comparatively high, the advertiser expects a profit higher than that and makes a request for the advertisement.

According to the embodiment discussed above, there has been explained the procedure of enhancing the advertisement effect in the case where the user accesses the Web site on the Internet. The embodiment of the present invention is not, however, limited to this procedure. For instance, the embodiment of the present invention can be carried out also in the variety of services that follow.

(1) In call services for cellular phones, fixed phones, etc., there is a service in which a common carrier runs a voice advertisement before a start of the call, and, if the user listen to this voice advertisement, a call charge is discounted or the call becomes free of charge within a fixed period of time thereafter. In such a service, a keyword acquired when listening to the voice advertisement is repeated by uttering. Such a repetition is recognized in an automatic voice recognition system on the side of the common carrier. Then, if the user repeats the correct keyword, the call charge may be discounted or the call may be set free of charge within a fixed period of time thereafter.

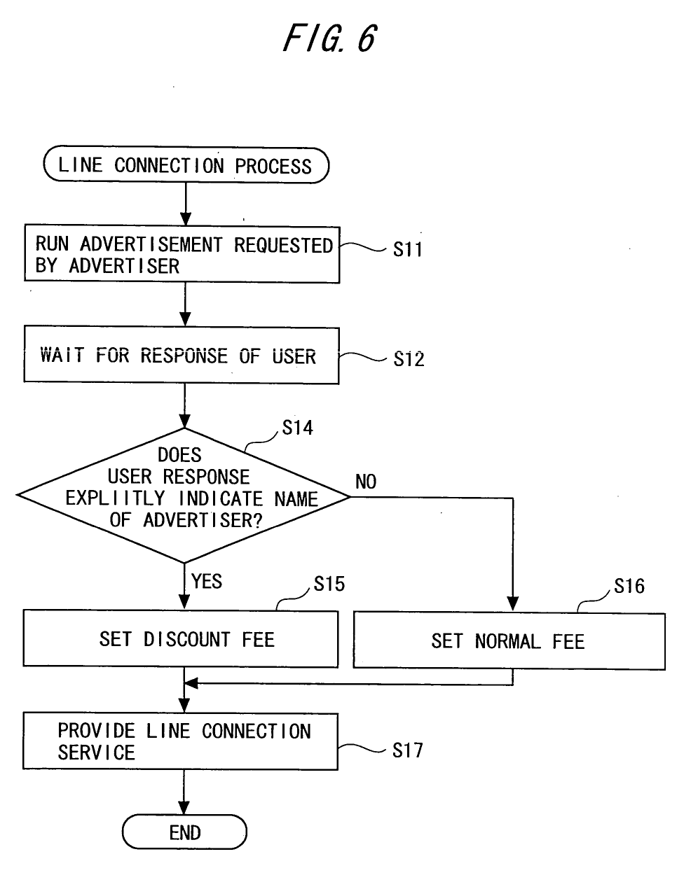

FIG. 6 shows a line connection process of such a telephone switching system. This process is executed by a CPU of the telephone switching system (unillustrated) when a line connection request is given from the user.

To begin with, this telephone system outputs the advertisement requested by the advertiser to the user's telephone (S11). Then, the telephone switching system waits a response from the user for a predetermined period of time (S12).

When the response is given from the user within the predetermined period or time, the telephone switching system judges whether a voice (phonemes) explicitly indicating the advertiser exists in the head of this response voice pronounced (S14). When the phonemes explicitly indicating the advertiser exist in the head of the response voice, the telephone switching system sets a discount charge (S15).

While on the other hand, when the phonemes explicitly indicating the advertiser do not exist in the head of the response voice, a normal charge is set (S16).

Thereafter, the telephone switching system provides the line connection service (S17). If the user requests the line to be disconnected, the telephone switching system terminates the line connection service.

(2) In the case of running the advertisement by a bidirectional communication means (such as a digital television, a CATV (Cable television), etc.), the same system can be built up in a way that provides a means (an upward line) by which the keyword is repeated from the user.

Namely, the broadcasting side of the digital television, the CATV, etc. monitors a response of an audience via the upward line in an advertising time zone before and after providing a program. When receiving a keyword related to this advertisement, e.g., a word(s) specifying the advertiser or a name of the commercial article from the audience, a watching charge of this program may be discounted, or a watching time may be extended.

As discussed above, the present invention can be embodied in the general type of systems for providing the services and advertisements through the bidirectional communications.

<<Readable-by-Computer Recording Medium>>

A program or data for making a computer actualize any one of the functions of the information processing system in the embodiment discussed above can be recorded on a readable-by-computer recording medium. Then, the computer is made to read and execute the program or the data on this recording medium, whereby any one of the functions of the information processing system exemplified in the embodiment discussed above can be provided.

Herein, the readable-by-computer recording medium connoted herein is a recording medium capable of accumulating information such as data, programs, etc. electrically, magnetically, optically and mechanically or by chemical action, which can be read from the computer. What is demountable out of the computer among those recording mediums may be, e.g., a floppy disk, a magneto-optic disk, a CD-ROM, a CD-R/W, a DVD, a DAT, an 8 mm tape, a memory card, etc.

Further, a hard disk, a ROM (Read Only Memory) and so on are given as recording mediums fixed within the computer.

<<Data Communication Signal Embodied in Carrier Wave>>

Furthermore, the above program can be stored in the hard disk and the memory of the computer, and can be distributed to other computers via communication media. In this case, the program is transmitted as data communication signals embodied in carrier waves via the communication media. Then, the computer that received the distributed program can be made to provide any one of the functions.

Herein, the communication media may be any one of cable communication mediums such as metallic cables including a coaxial cable and a twisted pair cable, optical communication cables, or wireless communication media such as satellite communications, ground wave wireless communications, wireless LANs, Bluetooth, etc.

Further, the carrier waves are electromagnetic waves for modulating the data communication signals, or the light. The carrier waves may, however, be DC signals. In this case, the data communication signal takes a base band waveform with no carrier wave. Accordingly, the data communication signal embodied in the carrier wave may be any one of a modulated broadband signal and an unmodulated base band signal (corresponding to a case of setting a DC signal having a voltage of 0 as a carrier wave).

### Industrial Applicability

The present invention can be utilized in an advertisement industry, a data communication service industry, a content providing service industry, a television broadcasting business, a cable television business, and so on.

What is claimed is:

1. A service providing method of providing a service together with advertisement information by utilizing bidirectional communications, comprising steps of:
providing the advertisement information;
prompting an input of identifying information related to the advertisement information; and
providing the service after the identifying information has been inputted.

2. A service providing method according to claim 1, wherein the identifying information is information on a name of an enterprise, a name of a commercial article, a brand and a trademark as an advertising target based on the advertisement information, information describing the enterprise, information describing the commercial article, information exhibiting an advertising effect with respect to the enterprise, information exhibiting an advertising effect with respect to the commercial article, or a name of an organization.

3. A service providing method according to claim 1, further comprising a step of charging the enterprise as the advertising target based on the advertisement information or the enterprise related to the commercial article as the advertising target based on the advertisement information, a fee for providing the advertisement information.

4. A service providing method according to claim 1, wherein the service is a service of distributing a digital content.

5. A service providing method according to claim 3, wherein the fee is determined based on an input count of the identifying information.

6. A server device, connected to a terminal device through bidirectional communications, providing a service together with advertisement information to said terminal device, comprising:
a providing module providing the advertisement information to said terminal device;
a prompting module prompting an input of identifying information related to the advertisement information via said terminal device, and reading the identifying information; and
a service module providing the service after the identifying information has been inputted.

7. A server device according to claim 6, wherein the identifying information is information on a name of an enterprise, a name of a commercial article, a brand and a trademark as an advertising target based on the advertisement information, information describing the enterprise, information describing the commercial article, information exhibiting an advertising effect with respect to the enterprise, information exhibiting an advertising effect with respect to the commercial article, or a name of an organization.

8. A server device according to claim 6, further comprising accounting a charging module charging the enterprise as the advertising target based on the advertisement information or the enterprise related to the commercial article as the advertising target based on the advertisement information, a fee for providing the advertisement information.

9. A server device according to claim 6, wherein the service is a service of distributing a digital content.

10. A server device according to claim 8, wherein said accounting module determines the fee on the basis of an input count of the identifying information.

11. A readable-by-computer recording medium recorded with a program for making a computer connected to a terminal device through bidirectional communications, provide a service together with advertisement information, said program comprising steps of:
providing the advertisement information to said terminal device;
prompting an input of identifying information related to the advertisement information via said terminal device; and
providing the service after the identifying information has been inputted.

12. A readable-by-computer recording medium recorded with a program according to claim 11, wherein the identifying information is information on a name of an enterprise, a name of a commercial article, a brand and a trademark as an advertising target based on the advertisement information, information describing the enterprise, information describing the commercial article, information exhibiting an advertising effect with respect to the enterprise, information exhibiting an advertising effect with respect to the commercial article, or a name of an organization.

13. A readable-by-computer recording medium recorded with a program according to claim 11, wherein said program further comprises charging the enterprise as the advertising target based on the advertisement information or the enterprise related to the commercial article as the advertising target based on the advertisement information, a fee for providing the advertisement information.

14. A readable-by-computer recording medium recorded with a program according to claim 11, wherein the service is a service of distributing a digital content.

15. A readable-by-computer recording medium recorded with a program according to claim 13, wherein the fee is determined based on an input count of the identifying information in said charging step.

16. A program for making a computer connected to a terminal device through bidirectional communications, provide a service together with advertisement information, comprising steps of:
providing the advertisement information to said terminal device;
prompting an input of identifying information related to the advertisement information via said terminal device; and
providing the service after the identifying information has been inputted.

17. A program according to claim 16, wherein the identifying information is information on a name of an enterprise, a name of a commercial article, a brand and a trademark as an advertising target based on the advertisement information, information describing the enterprise, information describing the commercial article, information exhibiting an advertising effect with respect to the enterprise, information exhibiting an advertising effect with respect to the commercial article, or a name of an organization.

18. A program according to claim 16, further comprising charging the enterprise as the advertising target based on the advertisement information or the enterprise related to the commercial article as the advertising target based on the advertisement information, a fee for providing the advertisement information.

19. A program according to claim 16, wherein the service is a service of distributing a digital content.

20. A program according to claim 18, wherein the fee is determined based on an input count of the identifying information in said charging step.
